(19) United States
(12) Patent Application Publication
(10) Pub. No.: US 2024/0165567 A1
(43) Pub. Date: May 23, 2024

(54) POROUS CERAMIC FILTRATION MEMBRANES WITH TUNABLE AND MULTI-SCALE POROSITY

(71) Applicant: Lawrence Livermore National Security, LLC, Livermore, CA (US)

(72) Inventors: Alyssa Lanae Troksa, Pleasanton, CA (US); Hannah Violet Eshelman, Dublin, CA (US); James Kelly, San Francisco, CA (US); Maira Raquel Ceron Hernandez, Brentwood, CA (US)

(21) Appl. No.: 18/388,459

(22) Filed: Nov. 9, 2023

Related U.S. Application Data
(60) Provisional application No. 63/426,622, filed on Nov. 18, 2022.

(51) Int. Cl. B01D 71/02; B01D 67/00; B33Y 10/00; B33Y 70/10; B33Y 80/00

(52) U.S. Cl. CPC B01D 71/02; B01D 67/0062; B33Y 10/00; B33Y 70/10; B33Y 80/00

(57) ABSTRACT

A ceramic mixture for forming a ceramic material includes ceramic nanoparticles, a primary pore former polymer capable of crosslinking, a secondary pore former polymer configured to form micron-sized pores in the ceramic material, and a polymerization initiator.

### RELATED APPLICATIONS

This application claims priority to U.S. Provisional Appl. No. 63/426,622 filed on Nov. 18, 2022, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to porous ceramic material, and more particularly, this invention relates to preparation of porous ceramic membranes using a sacrificial polymer template in conjunction with micron-sized polymer beads for use in filtration.

### BACKGROUND

Controlling the structure across multiple length scales is key to developing materials with multiple applications. Additive manufacturing (AM) techniques, also known as 3D printing, have revolutionized the production of countless structures at different scales using all types of materials and have enabled the creation of lighter, stronger parts and systems that would otherwise have been impossible to create with conventional techniques. Direct ink write (DIW) manufacturing is one AM technique that can be used for such purposes and forms parts by extruding ink while translating either the extrusion nozzle or part. DIW extrudes a shear thinning material through a nozzle to form a structure layer by layer on a translation stage. The use of ink as a feedstock is advantageous because it allows versatile compositions and complex geometries to be printed quickly. However, tuning the ink rheological behavior to flow through the nozzle while maintaining its shape retention properties is sometimes a challenge.

Additive manufacturing can produce parts with controlled structure over multiple length scales resulting in improved or even unconventional bulk properties and characteristics. Mechanical properties like strength are important for many applications, analyses of more complicated structures, and informing process optimization. However, it is not always easy, practical, or appropriate to use standard geometries and methods to test 3D printed materials and there is a need to develop simple testing methods conducive to testing parts in the as-manufactured condition and that can account for variable size effects associated with specific manufacturing conditions.

### SUMMARY

According to one embodiment, a ceramic mixture for forming a ceramic material includes ceramic nanoparticles, a primary pore former polymer capable of crosslinking, a secondary pore former polymer configured to form micron-sized pores in the ceramic material, and a polymerization initiator.

According to another embodiment, a ceramic product includes a printed three-dimensional structure comprising a ceramic material having an open cell structure with a plurality of pores. At least some groups of the pores connect through the ceramic material from one side of the ceramic material to an opposite side of the ceramic material. The plurality of pores comprise a plurality of nanopores and a plurality of micropores. A population of the micropores have a predefined size according to a geometry of the printed three-dimensional structure.

According to yet another embodiment, a method of forming a printed three-dimensional structure comprising a ceramic material includes forming a three-dimensional structure using a ceramic mixture. The ceramic mixture includes ceramic nanoparticles, a primary pore former polymer capable of crosslinking, a secondary pore former polymer configured to form micron-sized pores in the ceramic material, and a polymerization initiator. Furthermore, the method includes curing the ceramic mixture for crosslinking the primary pore former polymer and sintering the structure for removing the polymers and densifying the structure to about a predefined extent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic diagram of components of a ceramic mixture for forming a structure having microporosity and nanoporosity, according to one embodiment.

FIG. 2 is a flow chart of a method of forming a porous ceramic structure, according to one embodiment.

FIG. 3A is a schematic diagram of a direct ink writing process with a printing nozzle, according to one embodiment.

FIG. 3B is an image of a top down view of a log-pile three dimensional structure formed by direct ink writing. FIG. 3B includes a magnified view of a portion of the structure.

FIG. 3C is an image of a perspective view of a log-pile three dimensional structure formed by direct ink writing.

FIGS. 3D-3F are images of various perspective views of a cylindrical three dimensional structure formed by direct ink writing, according to one embodiment.

FIG. 4A is a schematic drawing of a process of projection micro-stereolithography.

FIG. 4B is a schematic drawing of a process of projection micro-stereolithography of high viscosity materials, according to one embodiment.

FIG. 5 is schematic drawing of a ceramic product comprising a nanoporous and microporous ceramic material, according to one embodiment.

FIG. 6 is a series of images of mini-tubes formed with a ceramic ink, according to one embodiment. Part (a) is an image of a jar of ceramic mini-tubes, part (b) is a magnified image of a tube in part (a), part (c) is a magnified image of a portion of part (b), and part (d) is a magnified image of a portion of part (c).

FIG. 7 is a series of images of a lattice ceramic cylinder, according to one embodiment. Part (a) is a perspective view of a lattice ceramic cylinder, part (b) is a top down view of the lattice ceramic cylinder, part (c) is a magnified view of a portion of the top down view of part (b), and part (d) shows a comparison of a cured ceramic cylinder and a sintered ceramic cylinder.

FIG. 8 is a series of images of lattice cylinder tubes formed with a ceramic mixture, according to one embodiment. Part (a) is a perspective view of the ceramic tubes, and part (b) is a top-down view of the ceramic tubes.

FIG. 9 represents an experimental procedure for the dimetral compression of direct ink written 3YZ tubes, according to one embodiment. Part (a) is an image of the compression apparatus, part (b) is an image of the top view of a ceramic tube, part (c) is an image of the side view of a ceramic tube, part (d) is a plot of a force displacement curves of a series of ceramic tubes.

FIG. 10 depicts the properties of ceramic inks with and without a secondary pore former polymer, according to one embodiment. Part (a) is a log-log plot of shear rate vs. viscosity of the ceramic inks. Part (b) is a log-log plot of oscillation stress vs. storage modulus of the ceramic inks.

FIG. 11 is a series of images of cured ceramic material, according to one embodiment. Part (a) is an image of ceramic structures formed with different inner diameters. Parts (b), (c), and (d) are images showing the ceramic material at different magnifications.

FIG. 12 is a series of images of cured ceramic material formed with a ceramic mixture having polystyrene beads, according to one embodiment. Part (a) is a lower magnification of the material, and part (b) is a magnified portion of the material in the image of part (a).

FIG. 13 is a plot of a failure probability versus indirect tensile stress for a series of ceramic structures, according to one embodiment.

FIG. 14 is a plot of ceramic tube diametral testing, according to one embodiment.

FIG. 15 depicts the rheology of a series ceramic inks with and without an additive, according to one embodiment. Part (a) is a plot of the rheology of an ink including 3YZ ceramic nanoparticles and PEGDA, part (b) is a plot of the rheology of an ink including 3YZ ceramic nanoparticles, PEGDA, and a dispersant SS20K, and part (c) is a plot of the rheology of an ink including 3YZ ceramic nanoparticles, PEGDA, and a dispersant SS41K.

FIG. 16A is a series of images of a ceramic structure formed with dispersant PEG400, according to one embodiment. Parts (a) and (b) depict images of two sides of a formed structure, part (c) is a magnified image of the structure formed in image of part (d).

FIG. 16B is a series of images of a ceramic structure formed with dispersant SS20K, according to one embodiment. Parts (a)-(d) depict images of one sample, parts (b) and (d) being magnified views of the images of parts (a) and (c), respectively. Parts (e)-(h) depicts images of another sample, parts (f) and (h) being magnified views of the images of parts (e) and (g), respectively.

FIG. 16C is a series of images of a ceramic structure formed with dispersant SS41K, according to one embodiment. Parts (a)-(d) depict images of one sample, parts (b) and (c) being magnified views of the images of parts (a) and (d), respectively. Parts (e)-(h) depicts images of another sample, parts (f) and (h) being magnified views of the images of parts (e) and (g), respectively.

FIG. 17 is a series of images of a ceramic lattice formed with a ceramic mixture, according to one embodiment. Part (a) is an image of a portion that illustrates edge cracking, part (b) is an image of a portion that illustrates edge cracking with separation, part (c) is an image of a portion that illustrates a raised region, and part (d) illustrates a region without visual defects.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A nanoscale, nanoporous, etc. is defined as having a diameter or length (e.g., a pore having an average diameter) less than 1000 nanometers (nm). A microscale, microporous, micron-sized, etc. is defined as having a diameter or length (e.g., a pore having an average diameter) less than about 1000 microns (μm).

As used herein, the term “essentially” denotes an interval of accuracy that ensures a meaning of “mostly” but may not be exclusively 100%. The term “essentially” may denote 99.0% to 99.9%.

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The present disclosure includes several descriptions of exemplary “inks” used in an additive manufacturing process to form the inventive concepts described herein. It should be understood that “inks” (and singular forms thereof) may be used interchangeably and refer to a composition of matter comprising a plurality of nanoparticles coated with/dispersed throughout a liquid phase such that the composition of matter may be “written,” extruded, printed, or otherwise deposited to form a layer that substantially retains its as-deposited geometry and shape with perhaps some, but preferably not excessive, sagging, slumping, or other deformation, even when deposited onto other layers of ink, and/or when other layers of ink are deposited onto the layer. As such, skilled artisans will understand the presently described inks to exhibit appropriate rheological properties to allow the formation of monolithic structures via deposition of multiple layers of the ink (or in some cases multiple inks with different compositions) in sequence.

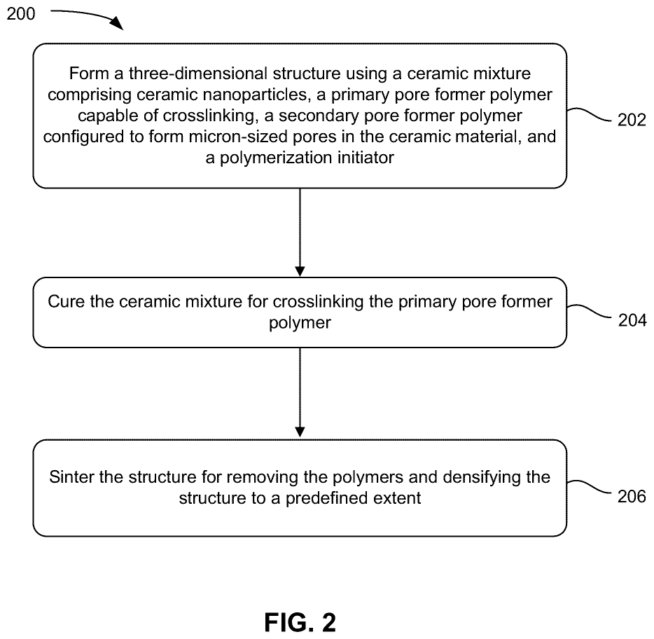

The following description discloses several preferred structures formed via direct ink writing (DIW), extrusion freeform fabrication, or other equivalent techniques and therefore exhibit unique structural and compositional characteristics conveyed via the precise control allowed by such techniques. The physical characteristics a structure formed by DIW may include having lower layers of the structure are slightly flattened, slightly disfigured from original extrusion (e.g., see slight droop of the filament in FIG. 2), etc. by weight of upper layers of structure, due to gravity, etc. The three-dimensional structure formed by DIW may have a single continuous filament that makes up at least two layers of the 3D structure.

The following description discloses several preferred structures formed via photo polymerization processes, e.g., projection micro-stereolithography, photolithography, two photon polymerization, etc., or other equivalent techniques and therefore exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The formation of a three-dimensional structure includes exposing a resin to light, where a pattern in the photoresist is created by the exposing light.

The following description discloses several preferred embodiments of forming porous ceramic filtration membranes with tunable and multi-scale porosity of and/or related systems and methods.

In one general embodiment, a ceramic mixture for forming a ceramic material includes ceramic nanoparticles, a primary pore former polymer capable of crosslinking, a secondary pore former polymer configured to form micron-sized pores in the ceramic material, and a polymerization initiator.

In another general embodiment, a ceramic product includes a printed three-dimensional structure comprising a ceramic material having an open cell structure with a plurality of pores. At least some groups of the pores connect through the ceramic material from one side of the ceramic material to an opposite side of the ceramic material. The plurality of pores comprise a plurality of nanopores and a plurality of micropores. A population of the micropores have a predefined size according to a geometry of the printed three-dimensional structure.

In yet another general embodiment, a method of forming a printed three-dimensional structure comprising a ceramic material includes forming a three-dimensional structure using a ceramic mixture. The ceramic mixture includes ceramic nanoparticles, a primary pore former polymer capable of crosslinking, a secondary pore former polymer configured to form micron-sized pores in the ceramic material, and a polymerization initiator. Furthermore, the method includes curing the ceramic mixture for crosslinking the primary pore former polymer and sintering the structure for removing the polymers and densifying the structure to about a predefined extent.

A list of acronyms used in the description is provided below.
3D three-dimensional
3YZ 3 mol. % partially stabilized zirconia
8YZ 8 mol. % stabilized zirconia
AM additive manufacturing
C Celsius
DIW direct ink writing
ID inner diameter
ms millisecond
nm nanometer
OD outer diameter
PμSL projection micro-s tereolithography
μm
micron
wt. % weight percent

Sufficient ink extrudability and filament shape fidelity depend on stringent rheological requirements paired with the specific printing conditions and the rheological properties depend on ink formulation. As described herein, various embodiments include a ceramic ink that includes nano and microporosity within, by adding different particle size sacrificial templates, that can be then 3D printed to introduce macroporosity as desired.

According to one embodiment, several ceramic inks for 3D printing include ceramic nanoparticles (e.g., partially stabilized zirconia (e.g., 3YZ, 8YZ), alumina, ceria, calcium zirconate, etc.) through compositional tuning that are compatible with two AM techniques, DIW and projection micro-stereolithography (POL). The ceramic inks can produce parts engineered over multiple length scales with macro cavities measuring several millimeters in lengths controlled primarily by part design. In one approach, ceramic inks comprising 3YZ nanoparticle form nanoporous ceramic printed parts having engineered macro cavities measuring several millimeters in lengths, having wall thicknesses ranging from 200 to 1600 μm controlled primarily through nozzle selection, and having a homogenous nanoporosity (e.g., −100 nm) within the wall structure controlled primarily through ceramic nanoparticle sizes in the ink and thermal processing parameters.

As described herein, tensile strength of porous ceramic tubes is measured indirectly through diametral compression. A tube is a convenient geometry easily manufactured by DIW 3D printing, tubes were manufactured by printing with an ink containing partially stabilized zirconia nanoparticles and sacrificial pore former polymers. The resulting material has a combination of open nanoporosity and closed microporosity after thermal processing to decompose the sacrificial pore former polymer and partially sinter the nanoparticles. The tube geometry was varied to show that characteristic strengths, established by Weibull analyses, follow a size dependent relationship originally developed to evaluate rocks by diametral compression.

Mechanical properties are a key characterization tool for new materials and their processing in emerging technologies. Ceramic materials are traditionally tested in compression or flexure rather than tension due to their brittle nature and sensitivity to flaws; however, ceramics are much weaker in tension and typically fail due to tensile loading. Diametral compression test is typically used to indirectly measure the tensile strength of a ceramic. Also called the Brazilian test, the diametral compression test has been used extensively to indirectly measure experimental or technological tensile strengths of rocks, concretes, and ceramics. According to various approaches, the mechanical strength of ceramic products is described using a diametral compression test of 3YZ porous ceramic tubes, 3D printed with various inner-to-outer diameter ratios (ID:OD) using DIW.

The benefits of the addition of a polyethylene powder (e.g., Ceracer) into the 3YZ ink may be two-fold: it increases the porosity and improves the rheological properties for DIW printing. Additionally, since the new formulation has better printing properties and higher porosity, it is an ideal material to study the mechanical behavior observed during the diametral compression testing.

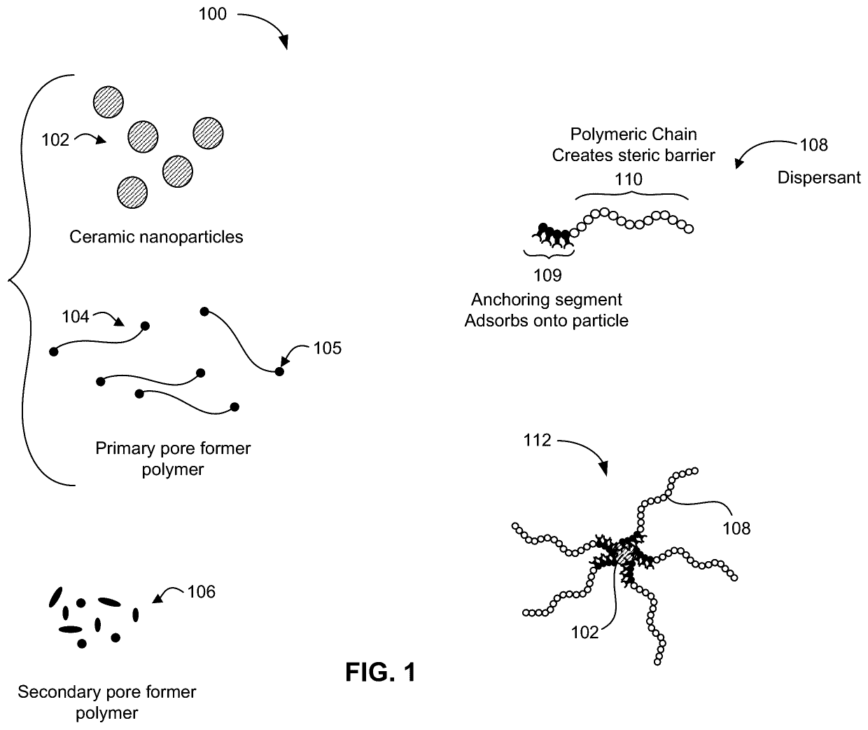

In one embodiment, a formulation of a ceramic mixture for forming a ceramic material includes ceramic nanoparticles, a primary pore former polymer capable of crosslinking, a secondary pore former polymer configured to form micron-sized pores in the ceramic material, and a polymerization initiator. As illustrated in FIG. 1, for example, a ceramic mixture 100 may include the following components: ceramic nanoparticles 102, a primary pore former polymer 104 having functional groups 105 that are capable of crosslinking, and a secondary pore former polymer 106 being particles that form micron-sized pores in the ceramic material.

The ceramic component may include ceramic nanoparticles that are preferably ceramic nanoparticles. In one approach, the ceramic nanoparticles include yttria stabilized zirconia. In various approaches, the ceramic nanoparticles include a composition of 3 mol. % yttria stabilized zirconia (3YZ) nanoparticles, 8 mol. % yttria stabilized zirconia (8YZ) nanoparticles, alumina (Al₂O₃), ceria (CeO₂), calcium zirconate (Ca₇rO₃), etc. The ceramic nanoparticles may be selected according to desired mechanical properties of the cured and sintered printed part. In some approaches, pore size and mechanical properties of the printed part may be tuned with different types of ceramic nanoparticles.

For various embodiments, the ceramic mixture may be tuned for application for AM techniques by adjusting the nanoparticle size and/or adjusting the solids loading of the ceramic mixture. In one approach, the ceramic mixture may be configured as an ink for extrusion-based printing. In another approach, the ceramic mixture may be configured as a resin for light-based lithography printing.

The sizes of nanoparticles may include an average size (e.g., an average diameter) of 55 nm, 25 nm, etc. The solids loading of the ceramic nanoparticles may be adjusted to optimize shear thinning properties of the mixture for both extrusion-based printing (DIW) as an ink and light-based lithography printing (POL) as a resin.

A primary pore former polymer is a polymer that when mixed with the ceramic nanoparticles forms a homogenous mixture of polymer and ceramic nanoparticles. The primary pore former polymer may be configured to form nanopores in the formed ceramic material. The primary pore former is a polymer capable of crosslinking. The primary pore former polymer forms a network in the ink that results in a nanoporosity of the ceramic material after the polymer has been burned away. For example, the primary pore former polymer includes functional groups that are capable of crosslinking, such as acrylate group, carboxylic groups, thiol-ene groups, azide groups, etc., In preferred approaches, the primary pore former polymer included poly(ethyleneglycol) diacrylate (PEGDA) having a molecular weight of 575 (Mₙ 575), but the molecular weight may be higher or lower. The size of the polymer changes the viscosity of the ink, for example, some polymers become more viscous as the weight of the polymer increases. Concentrations of the secondary pore former polymer, surfactant, dispersants, etc. added to the ink are determined relative to the concentration of the primary pore former polymer having a particular Mₙ in order to adjust the viscosity of the ink for 3D printing. In one approach, PEGDA mixes well with ceramic nanoparticles to form a homogenous feedstock and forms a good network of ceramic nanoparticles after curing.

In one embodiment, the formulation includes forming a sub-mixture, i.e., a feedstock, of the ceramic nanoparticles (A) with the primary pore former polymer (B). In various approaches, A is about 50 to 80 wt. % of the total weight of the ceramic mixture, and A+B=100 wt. % of the sub-mixture. For example, a concentration of ceramic nanoparticles in the sub-mixture is in a range of about 50 wt. % to about 80 wt. % of the total weight of the sub-mixture. The concentration of the primary pore former polymer is complementary to the concentration of the ceramic nanoparticles. For example, a sub-mixture having 50 wt. % of ceramic nanoparticles preferably has 50 wt. % of primary pore former polymer, a sub-mixture having 60 wt. % of ceramic nanoparticles preferably has 40 wt. % of primary pore former polymer, a sub-mixture having 80 wt. % of ceramic nanoparticles preferably has 20 wt. % of primary pore former polymer. The higher concentrations of ceramic nanoparticles cause the ceramic mixture to have increased viscosity. The concentration of the secondary pore former polymer is complementary to the concentration of the primary pore former polymer. For example, a sub-mixture having 25 wt. % of primary pore former polymer preferably has 0 to 15 wt. % of secondary pore former polymer, calculated relative to the primary pore former polymer concentration. The concentration of the dispersant, lubricant, etc. additives is complementary to the concentration of the primary pore former polymer. For example, a mixture (e.g., ink, resin, etc.) having 25 wt. % of primary pore former polymer may have 0 to 15 wt. % of dispersant or lubricant additives, calculated relative to the primary pore former polymer concentration. Preferably, a mixture having 25 wt. % of primary pore former has greater than 0 up to 5 wt. % of dispersant or lubricant additives.

The concentration of the ceramic nanoparticles in the ceramic mixture may be tuned according to the AM technique. In one approach, the ceramic mixture is an ink for extrusion-based printing, such as direct ink writing. In another approach, the ceramic mixture is a resin for light-initiated lithography techniques, such as projection micro-stereolithography (PμSL).

For example, for PμSL applications, a resin mixture having lower viscosity is desired, so the concentration of ceramic nanoparticles may be around 50 wt. % of the feedstock (and 50 wt. % PEGDA). For DIW applications, an ink having higher viscosity is desired, so the concentration of ceramic nanoparticles up to 80 wt. % of the feedstock (and 20 wt. % PEGDA). At concentrations higher than 80 wt. % ceramic nanoparticles in the ceramic mixture, extrusion of the ink was difficult even under higher pressures could not be extruded through the nozzle.

The ceramic material includes a polymerization initiator. A thermal initiator is included to initiate thermal curing of the ceramic mixture after a part has been printed using the ceramic mixture. In preferred approaches, a thermal initiator is included in the ceramic mixture used as an ink for extrusion-based printing. An amount of thermal initiator is determined based on the amount of the primary pore former polymer component, e.g., PEGDA, in the mixture. For example, the concentration of thermal initiator was preferably 1 wt. % relative to the concentration of PEGDA in the feedstock. If concentrations of thermal initiator were used at higher concentrations relative to PEGDA, the cured product seemed to exhibit increased incidence of cracking in the material. If concentrations of thermal initiator were used at lower concentrations relative to PEGDA, the curing of the material may be inconsistent. In one approach, a thermal initiator included Luperox® at a concentration of 1-2 wt. % with respect to PEGDA.

For light-mediated lithography techniques, such as PμSL, a photoinitiator is included in the ceramic mixture with the thermal initiator. The photoinitiator is used to cure the polymer layer by layer during the printing of the part; then the thermal initiator is used to complete the cure of the part during heat treatment in an over before the sintering step. The amount of thermal initiator in a resin used in light-mediated lithography techniques is the same as the amount of thermal initiator in a mixture for DIW. In one approach the ceramic mixture having a photoinitiator may also have a photoinhibitor to control the photopolymerization of the material. In one exemplary approach, a photoinitiator may include 4-Methoxyphenol, (MEHQ, 0.1 wt. % with respect to PEGDA), isopropylthioxanone (ITX, 0.1-0.3 wt. % with respect to PEGDA), and 2-ethylhexyl 4-(dimethylamino)benzoate (EHDA, 0.1-0.6 wt. %) dissolved in 0.1 mL tetrahydrofuran (THF) and added with Luperox® 231.

A secondary pore former polymer is a micron-sized particle polymer. The secondary pore former polymer may be configured to form micropores in the formed ceramic material. In some approaches, the size of the particles may be selected to correspond to the desired micron-sized pores in the cured and sintered printed part. In some approaches, the average diameter of the particles of the secondary pore former polymer may vary according to the desired size of the micro-size pores in the formed material. In one approach, the secondary pore former polymer is a powder comprised of particles, where an average diameter of the particles is in a micron range, for example 1 μm≤particle diameter≤100 μm. In one exemplary approach, a secondary pore former polymer is a polyethylene powder having irregular shaped particles having an average diameter in a micron range. In one example, a secondary pore former is a polyethylene powder where the particles of the powder have an average diameter in a range of about 8 to about 12 μm (e.g., Ceracer 640, Shamrock Technologies, Newark, NJ).

It was surprising that the addition of the secondary pore former polymer to the ceramic mixture induced a change in the rheological behavior of the ceramic mixture that increased viscosity of the ceramic mixture and thus improved extrudability of the ceramic mixture ink for forming a part using direct ink writing. The addition of the secondary pore former polymer increased the viscosity of the ceramic mixture, so the mixture became well-suited for extrusion-based printing. The rheology behavior of the ceramic inks includes storage modulus and yield stress demonstrated improved ink stiffness in the inks having the secondary pore former polymer. It one approach, the addition of the secondary pore former polymer to the ceramic ink may expand the complexity of achievable DIW prints.

In addition, it was surprising that curing and sintering the part formed with a ceramic ink having the secondary micron-sized secondary pore former polymer (e.g., the polyethylene powder) resulted in an unfractured product, such that the sintered part exhibited a minimal number of micro cracks in the ceramic material, where the cracks had a length and width in the microscale. In other approaches, curing and sintering a part printed with a ceramic ink without the secondary pore former polymer, resulted in formation of cracks in the sintered ceramic part.

Without wishing to be bound by any theory, the primary pore former polymer material tended to result in more micro-cracking in the sintered part. In sharp contrast, the inclusion of the secondary pore former polymer, e.g., polyethylene powder, formed a continuous network of pores, such as an evenly distributed porosity throughout the material, and did not result in extensive microcracking.

The concentration of secondary pore former polymer was added relative to the feedstock comprising ceramic nanoparticles and primary pore former polymer. In various approaches, the concentration of secondary pore former polymer may be added in a range of 0 wt. % up to about 15 wt. % of the weight of primary pore former polymer. At concentrations above 15 wt. % the secondary pore former polymer increased the viscosity of the ceramic mixture (e.g., ink, resin) to be almost like a putty instead of a paste. Moreover, the structures formed with ceramic mixtures having higher than 15 wt. % secondary pore former polymer tended to be mechanically unstable (e.g., brittle, excessive cracking, etc.) after the sintering step when the polymers were removed.

According to an exemplary approach, a ceramic ink includes a mixture of a feedstock comprising 65 wt. % 3 mol. % yttria partially stabilized zirconia (3YZ) and a primary pore former polymer 35 wt. % PEGDA (feedstock has a total 100 wt. %), with the addition of a secondary micron-sized pore former polymer, such as polyethylene powder (e.g., Ceracer 640) at a concentration of 10 wt. % relative to the feedstock and a 1 wt. % thermal initiator to create a resulting ink with solids loading of 80 wt. % of total mixture.

In some approaches, the ceramic mixture includes an additive. In one approach, where the ceramic mixture is used as an ink, the high concentration of nanoparticles are quite heavy relative to the polymer, so the nanoparticles may settle out of the solution. Thus, in order to diminish the settling rate of the ceramic nanoparticles, dispersants may cause the nanoparticles to disperse within the polymer and thereby allow the ink to have a longer shelf life without precipitation of the ceramic nanoparticles (i.e., settling of agglomerates of nanoparticles). In various approaches, any kind of surfactant may function as a dispersant.

The additive may be a dispersant, lubricant, non-ionic surfactant, etc. (e.g., polyethylene glycol, stearic acid, SS71k, etc.) to homogenously disperse ceramic nanoparticles in the polymer. In preferred approaches, the dispersant, lubricant, etc. additive is included in the formulation in addition to the primary pore former polymer and the secondary pore former polymer. In preferred approaches, a dispersant, lubricant, etc. additive may promote extrudability of the ink with less clogging and decrease micro-cracking in the cured and sintered product. In one approach, a formulation includes ceramic nanoparticles, a primary pore former polymer, a polymerization initiator, and an additive.

Looking back to FIG. 1, a ceramic mixture may include an additive such as a dispersant molecule 108. Each dispersant molecule 108 may include an anchoring segment 109 and a polymeric chain 110 that creates a steric barrier. An interaction 112 of a plurality of dispersant molecules 108 with a ceramic nanoparticle 102 prevents the ceramic nanoparticles 102 from interacting with each other. The anchoring segment 109 may adsorb onto the surface of the ceramic nanoparticle 102 allowing the polymeric chain 110 of the dispersant molecule 108 to create a steric barrier around the ceramic nanoparticle 102. The interaction between a dispersant molecule and the ceramic nanoparticle may be enhanced by matching the surface functionality of the dispersant molecule with the surface functionality of the ceramic nanoparticle thereby resulting in a strong hydrogen bond between the two components. Several dispersant molecules may associate with one ceramic nanoparticle, so that each nanoparticle has polymer tails extending from the nanoparticle. In the absence of dispersants, ceramic nanoparticles (such as 3YZ nanoparticles) tend to form agglomerates because they have an affinity for each other, and then the agglomerates precipitate from the ink. The presence of dispersants with the nanoparticles provide the separation of the ceramic nanoparticles by making it difficult for the nanoparticles to interact with each other. The nanoparticles remain suspended within the polymer because the dispersant chains allow them to stay in suspension.

In one approach, the formulation may include an additive, such as a dispersant, lubricant, etc. Dispersants include UV curable dispersants, alcohol dispersants, etc. The additive may be present in an effective amount to promote dispersion of the ceramic nanoparticles in the ceramic mixture such that 98% of the ceramic nanoparticles do not settle out of the mixture after 1 hour at rest after agitation to achieve at least 98% ceramic nanoparticle suspension in the ceramic mixture.

In one approach, a concentration of a dispersant may be in a range of between 0.5 wt. % up to about 2 wt. % with respect to the concentration of the primary pore former polymer in the ceramic mixture. In one approach, a concentration of dispersant may include a range of 0.5 wt. % up to about 15.0 wt. % with respect to a primary pore former polymer in a ceramic mixture formulation. At concentrations higher than 15.0 wt. % of dispersant, the primary pore former polymer may form a network including the dispersant that may contribute to an increased presence of cracks in the product.

In one example, the ceramic mixture may include SS20k or SS41k (Solsperse™ hyperdispersants, Lubrizol, Wickliffe, OH). SS41 includes an acrylate monomer and a preferable solvent is ester ketone, alcohol, etc. SS20 is typically used in high polarity coating, and a preferable solvent is alcohol, water, etc. with primary application with carbon black, organic pigments, alcohol and acetate packaging inks, etc.

In one approach, an additive may include a small polymer. A small polymer may have a molecular weight (Mₙ) under 1000. An ink that does not include PEG400 produces a lot of visible cracks, and then the addition of PEG400 in the ink produces a structure having less cracks in the formed ceramic material. For example, a smaller polymer may include polyethylene glycol (PEG) having a Mₙ in a range of average 400 (400PEG) (Mₙ 380-420) to an average 600 (600PEG) (Millipore Sigma, St. Louis, MO). A PEG molecule has a smaller chain than the PEGDA molecules of the primary pore former polymer. The smaller chains of the PEG molecule compared to the PEGDA molecules prevents the formation of networks that may create defects (i.e., cracks) in the product after curing. The formation of cracks in the product may compromise the mechanical strength of the product.

In some approaches, formulations of a ceramic mixture may include dispersants to reduce the aggregation of nanoparticles to mitigate microcracking post curing, and before sintering.

In some approaches, an ink that includes a surfactant additive for altering the rheology of the ceramic mixture for additive manufacturing. The viscosity and shear rate of the ink may be assessed relative to the presence of a surfactant in the ink. Addition of a dispersant to the ink causes a change in the viscosity of the ink, the ink has less viscosity, i.e., the ink becomes thinner and more easily flowable through a nozzle. However, preferably the viscosity has a lower limit such that it is desirable to have a viscosity of the ink that allows the ink to hold its shape after extrusion through the nozzle. In an exemplary approach, the ink has a viscosity that allows extrusion through a nozzle without clogging the nozzle and also allows the ink to retain its shape after extrusion.

In another approach, a formulation of a ceramic mixture (e.g., ink, resin, etc.) for forming a nanoporous material with macro-sized cavities may not include additive. For example, the formulation of a ceramic mixture may not include an additional thixotropic agent, a stabilizer, a surfactant, a filler, a stiffening agent, a filler additive, etc.

FIG. 2 illustrates a method 200 for forming a ceramic material using a ceramic mixture, in accordance with embodiment. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative approaches listed herein. Further, the methods presented herein may be carried out in any desired environment. Moreover, greater or fewer operations than those shown in FIG. 2 may be included in method 200, according to various aspects. It should also be noted that any of the aforementioned features may be used in any of the approaches described in accordance with the various methods.

Operation 202 of method 200 includes forming a three-dimensional structure using a ceramic mixture. As described herein, a ceramic mixture includes ceramic nanoparticles, a primary pore former polymer capable of crosslinking, a secondary pore former polymer configured to form micron-sized pores in the ceramic material, and a polymerization initiator. In one approach, a ceramic mixture may include an additive in an effective amount to disperse the ceramic nanoparticles by absorbing the additive to a surface of the ceramic nanoparticles.

In various approaches, the mixture may be combined at room temperature. In some instances, temperature may vary as determined by the component of the mixture as generally understood by one skilled in the art. In various approaches, the feedstock (e.g., a sub-mixture) of the ceramic mixture comprising the ceramic nanoparticles and primary pore former polymer are mixed thoroughly until combined into a homogenous mixture. The mixing of the feedstock includes using an acoustic mixer (e.g., a LabRAM mixer) with a sequence of increasing g-force to break up agglomerates and disperse the ceramic nanoparticles in the primary pore former polymer.

After preparation of the homogenous feedstock mixture of ceramic nanoparticles and primary pore former polymer, the thermal initiator (and photoinitiator in light-mediated AM techniques) and secondary pore former polymer (micron-sized pore former polymer) are added to the feedstock using a mixer (e.g., a Thinky mixer, FlackTek mixer, etc. Once the initiator is added, the ceramic mixture, a resin, an ink, etc. is ready for printing.

In various approaches, the ceramic mixture may form a molded structure, a templated structure, or a 3D printed structure using additive manufacturing techniques.

As an example, the ceramic mixture may be used to form a monolith structure. The monolith structures are formed with added pressure of the ceramic mixture being cast in a disc form. The pressure from cast process forms cracks in the monolith structure. The manufacturing technique of casting produces micro-cracks in the formed product. To avoid crack formation a doctor blade with a sharp end may be used without applying pressure into casted slurry. Preferably, curing occurs right after casting to avoid particle settling and therefore crack formation.

According to one embodiment, the ceramic mixture, as an ink, resin, etc., for forming a 3D structure is highly scalable and compatible with additive manufacturing (AM) methods such as direct ink writing (DIW) and projection micro-stereolithography (POL). The method of forming the 3D structure, curing the structure (e.g., forming a green body), and partial sintering of the ceramic material are described in the methodology disclosed in U.S. Pat. Nos. 11,638,907 and 11,142,486 herein incorporated by reference.

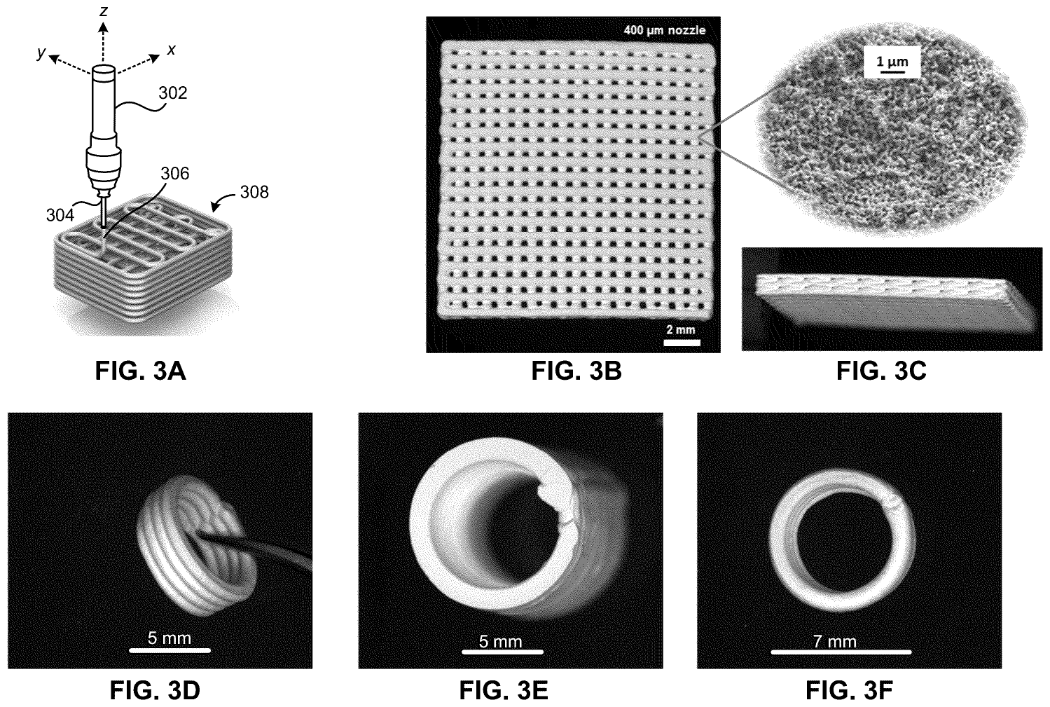

According to one embodiment, a ceramic structure may be formed using the ceramic mixture as an ink for forming a 3D structure using extrusion-based AM techniques, such as DIW as illustrated in FIGS. 3A to 3F. 3D printing of a ceramic ink allows extrusion of a bulk material to print struts in desired geometric patterns. A 3D printed ceramic structure may include a plurality of layers in which each layer is formed from the at least one filament (e.g., a first layer, a second layer, a third layer, etc.). In one approach, the filament may be a continuous filament forming all the layers of the structure.

FIG. 3A is a schematic drawing of an apparatus 302 with a nozzle 304 used in direct ink writing in which the ceramic mixture may be used as an ink 306 extruded from the nozzle 304. The apparatus 302 moves in three dimensions (as shown in arrows x, y, and z) to form a 3D structure 308 with the extruded ink 306. The ceramic mixture as described herein may be used as an ink to form a log-pile 3D structure as shown in FIG. 3B. A top down view of the structure is shown in FIG. 3B with a magnified view of a portion depicting the porosity of the 3D structure. FIG. 3C is a perspective view of the log-pile 3D structure formed by DIW.

FIGS. 3D-3F show the formation of a cylindrical 3D structure (e.g., a tube) using the ceramic mixture as an ink in DIW. The nozzle as shown in FIG. 3A extrudes the ceramic mixture in a continuous cyclic pattern to form a hollow cylinder 3D structure.

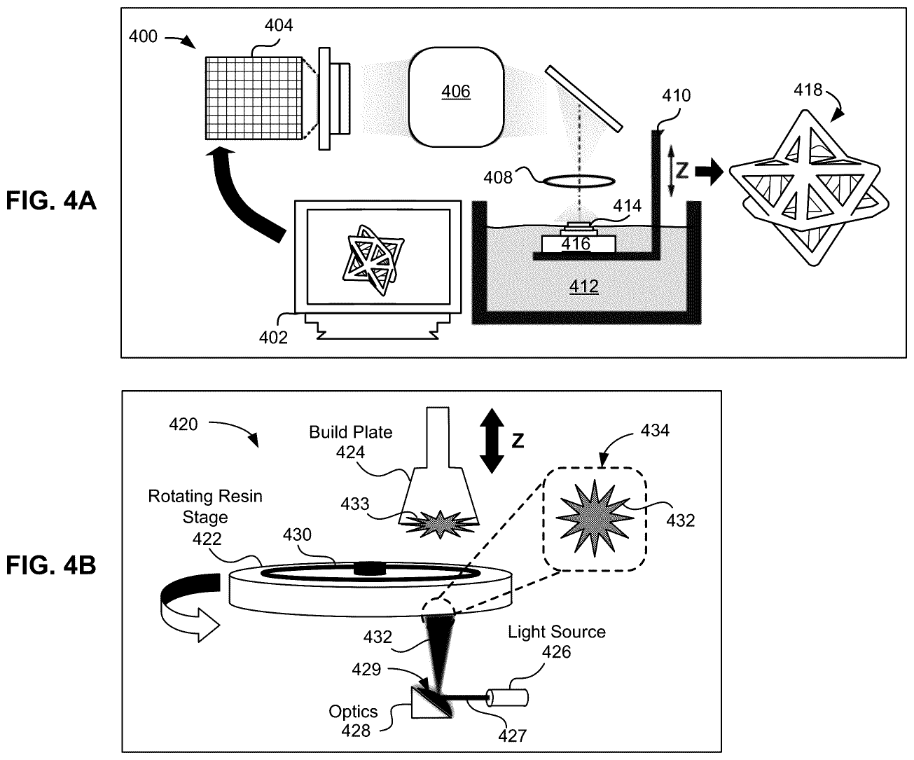

In another approach, using light-based AM techniques, a ceramic structure may be formed using the ceramic mixture as a resin for forming a 3D structure using a light-based lithography additive manufacturing technique (e.g., a PμSL system). FIG. 4A illustrates a schematic drawing of a process 400 of forming a 3D structure 414 using PμSL with a ceramic mixture used as a light-curable resin. Briefly, and as an example but not meant to be limiting in any way, a 3D CAD model 402 may be used for a digital mask 404 to shine a pattern of light via beam delivery 406. A pattern may be projected through a projection lens 408 onto a substrate 416 in a bath of ceramic resin 412. A 3D structure 414 may be formed as the projected light reacts with the ceramic resin 412, and subsequent layers of the forming 3D structure 414 are formed as the substrate 416 on the elevator 410 moves in the z-direction. From the ceramic resin 412, a ceramic/polymer part 418 (e.g., a green body) is formed.

As illustrated in FIG. 4B, the process 420 has evolved from the conventional process 400 of a PμSL method of printing structures using the ink described herein (see FIG. 4A). In one approach, the process 420 of FIG. 4B is a unique type of PμSL system for printing loaded resins, e.g., inks having a high viscosity. Briefly, as an example, and not meant to be limiting in any way, a light source 426 connected to a computer shines a light pattern 427 to an optics 428 having a mirror 429, e.g., a concave mirror, that magnifies and focus the light pattern 427 to be displayed as a defined magnified pattern 432 (as shown in the top view 434 of the defined magnified pattern 432). A 3D structure 433 may be formed on a Build Plate 424 as the projected light pattern 427 displays the defined magnified pattern 432 that reacts with the UV-curable ceramic/resin 430 on the Rotating Resin Stage 422. The Build Plate 424 moves in a z-direction to allow layers to be added to the 3D structure 433.

In preferred approaches, the ink used as the UV-curable ceramic/resin 430 of the PμSL process 420 includes an inhibitor for tuning the polymerization of the resin during printing.

AM techniques such as DIW printing demonstrate a significant reduction in cracks. The addition of surfactants, dispersants, etc. minimize the cracks in the printed structure. The ceramic mixture may be configured for extrusion-based printing (e.g., DIW printing) in order to diminish defects in the structure formed during the printing process. For example, defects such as edge cracking, separation, raised regions, etc. may be minimized for forming a uniform pattern where each extruded filament is complete without cracking across the length of the structure.

In some approaches, cylindrical tubes may be printed using an air powered fluid dispenser, with air pressures in a range of 15 to 40 psi to extrude the ceramic ink through a conical nozzle having a diameter ranging from 250 to 1600 μm. Printed cylindrical tubes may have dimensions including 2.4 mm outer diameter tubes with inner diameters between 0 and 1.6 mm. The diameter of the nozzle and the number of layers may be tuned to form cylindrical tubes having external cured dimensions in a range of greater than 1 mm outer diameter, greater than 1 mm height, and various inner diameters ranging from 0 to about 1.5 mm.

In various approaches, the 3D printed product has physical characteristics of formation by an additive manufacturing technique. In various approaches, physical characteristics may include filaments arranged in a geometric pattern, a patterned outer surface defined by stacking filaments, a defined porosity (e.g., ordered, controlled, non-random, etc.), a porosity having pores with measurable average diameters, etc. Thus, using these additive manufacturing techniques allows engineering of parts and production of optimal geometry for efficient mass transport and mechanical strength.

Referring back to FIG. 2, operation 204 of method 200 includes curing the ceramic mixture for crosslinking the primary pore former polymer. The formed structure is cured following the printing step, casting step, etc. to form a green body. The curing step includes heating the printed structure at a temperature in a range of room temperature to about 150° C. for a duration of time for curing the structure to a predefined extent. In an exemplary approach, the curing includes heating the structure to 120° C. for 12 hours under flow of nitrogen gas. Temperatures higher than 220° C. may induce decomposition of the structure material.

Following curing and formation of a green body of the printed part, cast part, etc., operation 206 includes sintering the structure for removing the polymers and densifying the structure to about a predefined extent. The formed green body is thermally processed at a temperature for removing the primary and secondary pore former polymers and to partially sinter the ceramic material. The thermal process preferably occurs in a box furnace (e.g., a Neytech Vulcan box furnace) to maintain porosity of the ceramic material.

The sintering profile is a series of steps that burn out the PEGDA polymer and then partially sinters the ceramic nanoparticles (e.g., 3YZ nanoparticles). In some approaches, the polymers may be removed beginning with a lower dwell temperature and slower heating rates at lower dwelling temperatures to allow gases formed during the burning process to leave the ceramic structure thereby resulting in less stress and less cracks. For example, polymers may be removed using a heating rate of 1° C./min and dwell temperatures and times of 200° C. for 2 h, 300° C. for 4 h, and 400° C. for 2 h, followed directly by partial sintering using a heating rate of 2° C./min and dwell temperatures and times of 800° C. for 4 h and 1090° C. for 15 h followed by directly cooling at a rate of 2° C./min.

In another approach, the sintering may be carried out at a higher temperature for a shorter duration of time to increase the mechanical strength of the ceramic material. In addition, a shorter-duration higher-temperature dwell step in the sintering profile may increase the porosity of the ceramic material. The sintering profile using less energy (e.g., shortened times) is advantageous for scaling up the process. In one approach, the sintering profile includes a series of heating steps that include a dwell temperature above 1100° C. for less than 8 hours. For example, in one exemplary approach, the sintering profile includes a heating rate of 1° C./min and dwell temperature at 150° C. for 1 h, followed directly by heating rate of 0.2° C./min and dwell temperature at 175° C. for 2 h, 200° C. for 2 h, 250° C. for 2 h and 300° C. for 2 h, followed directly by heating rate of 0.5° C./min and dwell temperature at 400° C. for 1 h, followed by partial sintering using a heating rate of 2° C./min and dwell temperatures and times of 800° C. for 4 h and 1100° C. for 5 h followed by directly cooling at a rate of 5° C./min.

In particular, the changes in this profile include a shorter amount of time at 1100° C., for example 5 hours at 1100° C. compared to 15 hours at 1050° C. In some approaches, the temperature may be higher at 1200° C. for up to one hour, e.g., 5 minutes (min), 15 min, 30 min, etc. The higher temperatures may result in closing some of the porosity of the product, however, the advantages include a mechanically stronger structure due to the increased densification of the material. A lower sintering profile allows a higher porosity. A shorter-duration higher-temperature sintering profile causes the part to shrink thereby resulting in a part having a higher density. A higher sintering profile allows a lower porosity with increased mechanical performance (e.g., mechanical strength) of the material.

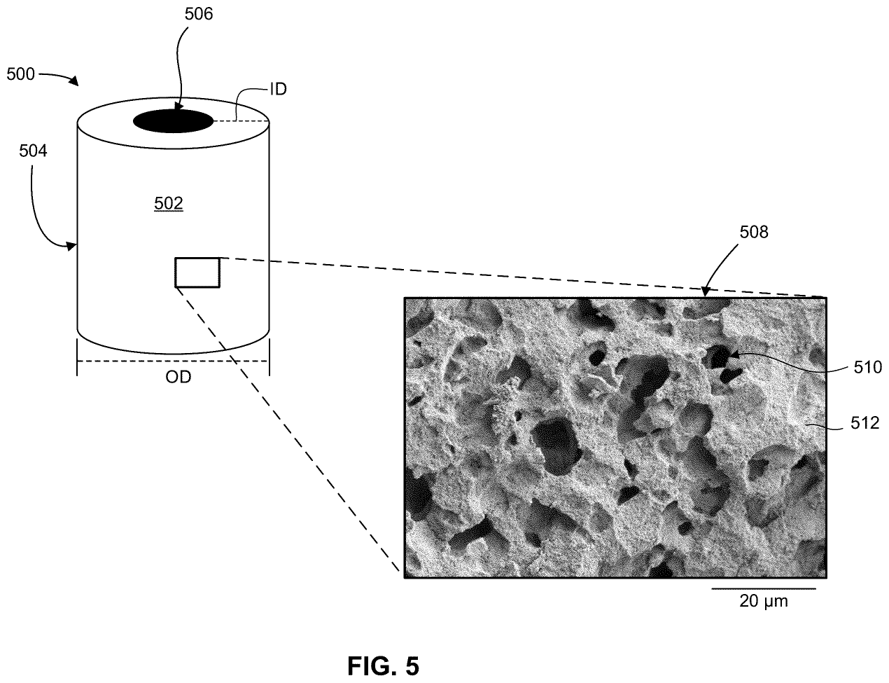

FIG. 5 depicts a ceramic product 500 comprising nanoporous ceramic material having micron-sized pores, in accordance with one aspect of an inventive concept. As an option, the present product 500 may be implemented in conjunction with features from any other inventive concept listed herein, such as those described with reference to the other FIGS. Of course, however, such product 500 and others presented herein may be used in various applications and/or in permutations which may or may not be specifically described in the illustrative embodiments listed herein. Further, the product 500 presented herein may be used in any desired environment.

In one embodiment, a ceramic product includes a printed 3D structure including a ceramic material having an open cell structure with a plurality of pores. At least some of the groups of the pores connect through the ceramic material from one side of the ceramic material to an opposite side of the ceramic material thereby creating open channels through the structure. The plurality of pores include a plurality of nanopores and a plurality of micropores, where a population of the micropores have a predefined size according to a geometry of the printed 3D structure.

In one example, as shown in the image of the ceramic product 500 includes nanoporous ceramic material 502, the ceramic product 500 may be formed as a printed part with geometric features. In one example, and not meant to be limiting in any way, the product 500 may be formed as a cylinder structure 504 having a cylindrical void 506 in the center that extends the length of the structure, such that that the product has an inner diameter ID and an outer diameter OD. A magnified view 508 of the nanoporous ceramic material 502 illustrates micron-sized pores 510 in the ceramic material having a plurality of nanopores 512. The micron-sized pores 510 were formed with particles having an average diameter of about 10 μm.

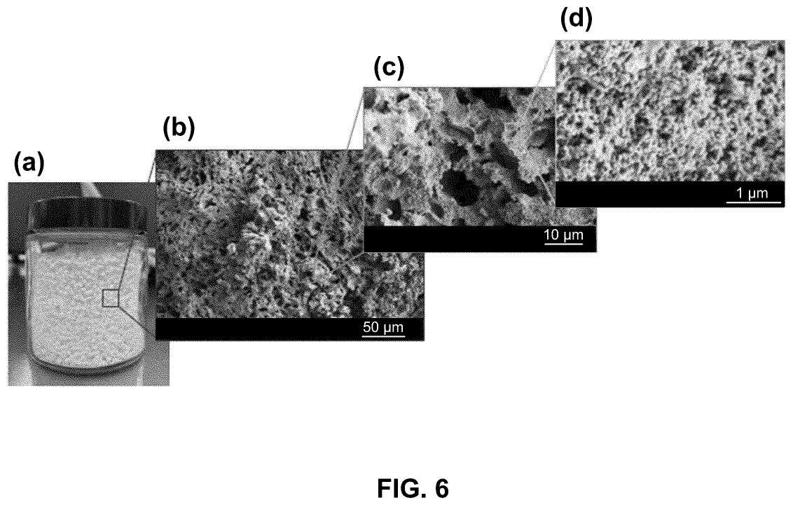

In one example using a ceramic ink comprising ceramic nanoparticles, a primary pore former (e.g., PEGDA), and a secondary pore former (e.g., Ceracer), as illustrated in FIG. 6, a plurality of mini cylinders can be formed using DIW techniques. The sintering profile of the mini cylinders includes the dwell step of 1090° C. for 15 hrs. As an example, only, the dimensions of the 2.1 mm mini cylinders shown in the image of a glass jar of part (a) have an average outer dimension (OD_{avg}) of 2.07±0.14 mm and an average inner dimension (ID_{avg}) of 0.925±0.05 mm. The average wall thickness of the mini cylinders is 0.58±0.08 mm. The average height (h_{avg}) of the mini cylinders is 1.61±0.11 mm, resulting in an aspect ratio of 1.28±0.14.

Part (b) is an image of a magnified view of the ceramic material of a mini cylinder showing nanopores and micropores in the material. The magnified view of the image of part (b) as shown in part (c) illustrates the larger micropores compared to the surrounding nanopores in the material. The micropores were formed from 15 wt. % of 1-10 μm particles (Ceracer particles) that were included in the ceramic mixture for forming the mini cylinders. The magnified view of a nanoporous region of part (c) as shown in part (d) illustrates the nanopores (having an average diameter of about 100 nm) throughout the ceramic material of the mini cylinders. The nanopores were formed from the crosslinked primary pore former polymer that was subsequently removed from the ceramic material using thermal processes to burn the polymer. The ceramic material was also partially sintered to densify the material.

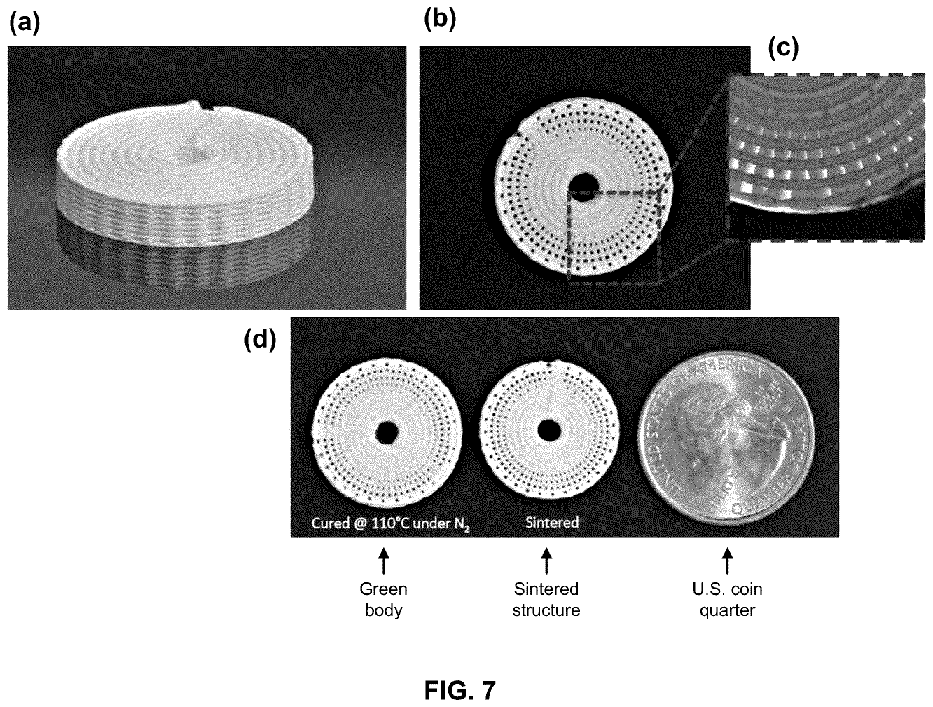

Extrusion-based additive manufacturing of the ceramic ink allows formation of complex 3D structures having predefined micro scale porosity. The micro scale porosity, in the 100 s of microns, may be defined by the geometry and arrangement of extruded filaments of the ceramic ink. In one example, as illustrated in FIG. 7, using extrusion-based DIW with a ceramic ink described herein, a cylinder having a complex lattice structure of predefined porosity may be fabricated. For purposes of demonstration, the ceramic ink includes 70 wt. % 3Y-ZrO₂ ceramic nanoparticles and the primary pore former PEGDA. Part (a) is an image of a perspective view of the 3D ceramic structure having a plurality of layers formed from a continuous extruded filament of ceramic ink. Part (b) is an image of a top-down view of the 3D ceramic structure having a cylindrical void in the center of the structure and micropores in the upper micron-range (e.g., 100's of microns) in a concentric formation. Part (c) is a magnified view of a portion of the image of part (b) that illustrates the gradient of concentric circles formed with the ceramic ink Part (d) is an image of green body of the 3D structure, a clear resolution of features of the structure sintered using the sintering profile having a dwell step of 1090° C. for 15 hr, and a U.S. quarter for comparison of sized (diameter of 24.26 mm).

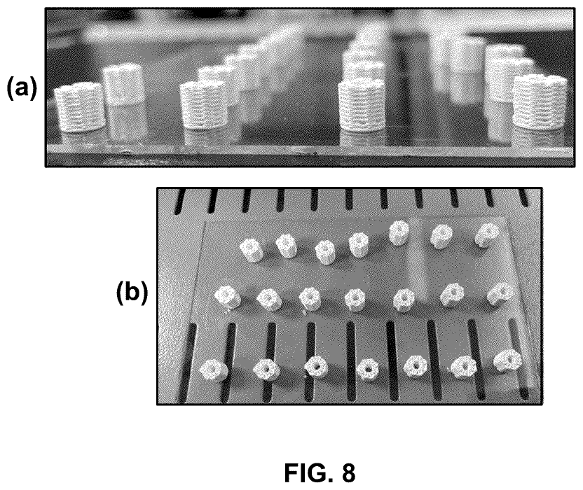

In yet another example, FIG. 8 illustrates the formation of mini tubes having a lattice structure for each layer using DIW extrusion-based techniques. The sintering profile includes the shorter-duration higher-temperature dwell step (1100° C. for 5 hrs). Part (a) is an image of a perspective view of a batch of formed mini cylinders. Part (b) is an image of a top-down view of a batch of formed mini cylinders. A circle disc is initially formed from a ceramic ink (e.g., 3YZ) in concentric circle layered piece that demonstrates the versatility and printability of fine features with the ceramic ink. The structure is printed to have macropores in the middle of the structure, micropores formed throughout the structure by printing a lattice-type structure, and nanopores in the material formed from the ink. The shorter-duration higher-temperature dwell step allows formation of structures having higher density nanoporous ceramic material with predefined microscale porosity.

The 3D ceramic structures formed with the ceramic mixture having primary and secondary pore former polymers may be used as a filter membrane, e.g., a HEPA filter.

Experiments

Ceramic inks were prepared following a previously reported procedure using a mixture of 3% yttria partially stabilized zirconia (3YZ), polyethylene glycol diacrylate (PEGDA 575), and a thermal initiator (Luperox® 231), with the addition of a secondary micron-sized pore former polymer, Ceracer 640 polyethylene powder (Shamrock Technologies, Newark, NJ), to create a resulting ink with solids loading of 80 wt. %. The rheological behavior of the 3YZ/Ceracer ceramic inks was measured using an AR2000ex rheometer (TA Instruments, New Castle, DE) following the procedure previously outlined to obtain viscosity, storage modulus, and yield stress values.1 3YZ tubes were printed using a custom Mechanical Gantry system with an Ultimus V, EFD air powered fluid dispenser, with air pressures of 24 to 39 psi to extrude the ceramic ink through Optimum® SmoothFlow™ tapered dispensing PTFE conical nozzles with diameters ranging from 250 to 1190 μm in an attempt to print 2.4 mm outer diameter tubes with inner diameters between 0 and 1.6 mm. Cylindrical tubes with external cured dimensions of 2.52±0.19 mm outer diameter and 2.3±0.22 mm height and 5 different inner diameters ranging from 0 to 1.265±0.04 mm were fabricated by adjusting the diameter of the nozzle and the number of layers printed (Table 1).

After printing, the resulting 3YZ DIW green body tubes were thermally cured at 120° C. for 12 h under nitrogen in a muffle furnace (1200C KSL-1200X Muffle Furnace, MTI, Richmond, CA). The green bodies were then partially sintered using the heating profile mentioned in our previous work to both remove the polymer and partially sinter the 3YZ nanoparticles. The internal nano- and microporosity of the resulting porous 3YZ tubes was confirmed using both an Apreo SEM (Thermo Fisher Scientific, Waltham, MA) with an accelerating voltage of 2 kV, working distance of 10.7 mm, 6.3×10-6 mbar vacuum chamber, and Everhart-Thornley SE detector (ETD), and a Phenom Desktop SEM (Thermo Fisher Scientific, Waltham, MA) with an accelerating voltage of 10 kV, 0.6 mbar vacuum chamber, and backscattered electron (BSE) detector.

Sample sets of at least thirty 3YZ DIW tubes were mechanically tested to failure under diametral compression using a universal mechanical testing system with a 500 Newton load cell (6800 Series, Instron, Norwood, MA, USA), flat loading platens, and a loading rate of 0.25 mm/min such that the samples would on average fail within 1 minute. The maximum force was used to calculate the indirect tensile strength for Weibull analysis. The indirect tensile strength formula is reliant on the maximum force or failure load, P, and the sample geometry (Equation 1).

$${σ}_{UTS} = \frac{2 PK}{π Dt} \qquad ( Equation 1 )$$

TABLE 1
DIW nozzle diameters corresponding to the resulting
cured tube inner diameter and number of layers
printed to achieve a heigh of 2.3 ± 0.22 mm.

| Optimum ® | | | Number of |
|---|---|---|---|
| SmoothFlow ™ nozzle | Tube Sample | Cured tube | printed |
| diameter (μm) | Set Label | ID (mm) | layers |
| 1190 | 00ID | 0 ± 0.00 | 2 |
| 840 | 04ID | 0.432 ± 0.04 | 3 |
| 584 | 08ID | 0.768 ± 0.05 | 4 |
| 406 | 12ID | 1.255 ± 0.05 | 6 |
| 250 | 16ID | 1.265 ± 0.04 | 10 |

Here, D is the sample outer diameter and t is the tube length. A stress concentration factor, K, is used to calculate the indirect tensile strength of ring or tube materials, and it is an approximate function, 6+38*r̅2̅, where r is the tube ID:OD. Each sample was evaluated under a Keyence VHX-7100 optical microscope (Keyence, Osaka, Japan), and sample dimensions were measured using ImageJ. Two perpendicular measurements were made across the tube diameter, four measurements were made in a cross pattern along the tube wall thickness, and two measurements were made along each side of the tube length. A most-likely estimator Weibull analysis of the hole size-corrected indirect tensile strength distribution was performed using OriginPro 2020.

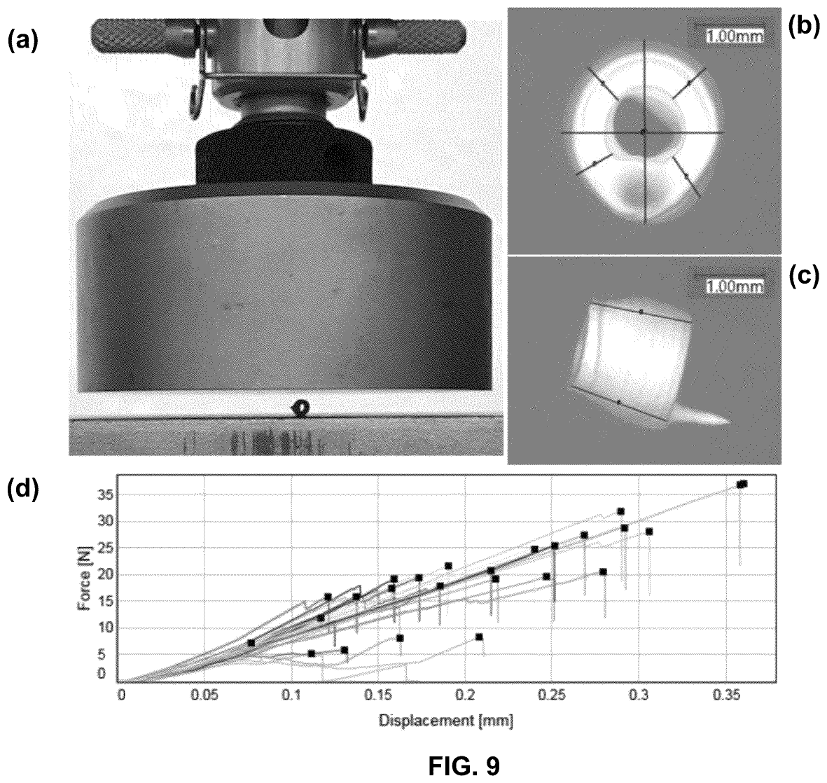

The mechanical testing setup is shown alongside an example of the obtained force-displacement data and an example of the 3YZ tube optical measurements in FIG. 9. The apparatus as shown in part (a) is a compression apparatus for the diametral compression tests of the ceramic tubes. A representative ceramic tube is shown in a top down view (part (b)) and a side view (part (c)) of FIG. 9. The plot of part (d) shows the force displacement data of 30 tubes undergoing diametral compression using the apparatus of part (a). The resulting force displacement curves are highly linear elastic. The indirect tensile strength was determined from the maximum force and the optically measured tube dimensions. Measurements of tensile strength included diametral compression test for the strength measurement of ceramics, e.g., discs and annuli (ASTM C496/C496M-17, Standard Test Method for Splitting Tensile Strength of Cylindrical Concrete Specimens, ASTM International, West Conshohocken, P A 2017, www.astm.org).

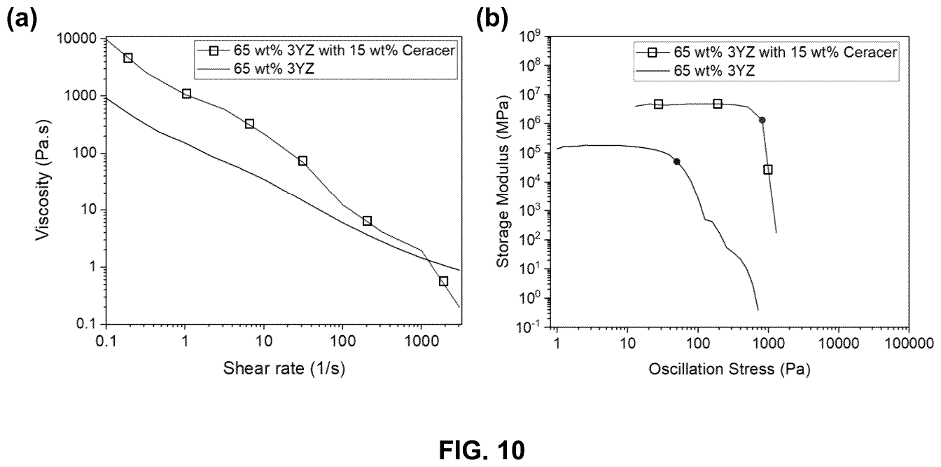

As seen in part (a) of FIG. 10, both inks, with and without Ceracer powder, are shear thinning. The viscosity of the 3YZ ink with 15 wt. % Ceracer powder added is about an order of magnitude higher at a shear rate of 1 1/s-1076 Pa·s compared to 152 Pa·s. These viscosity values both are consistent with previously reported values for highly loaded NP inks. In addition to the increased viscosity with the addition of Ceracer powder, there is a prominent increase in the storage modulus of the 3YZ/Ceracer ink. Part (b) of FIG. 10 compares the storage modulus and yield stress for same NP loaded 3YZ ink with and without Ceracer powder as a function of oscillation stress. Yield stress (denoted by the solid circular markers) is reported as 90% of the storage modulus plateau and is increased from 5×10⁵ to 1.3×10⁶ Pa with the addition of Ceracer powder; these values are also consistent with previously reported DIW NP loaded inks.

TABLE 2
Comparison between measured and expected ID:OD values
for cured and sintered 3YZ tubes. ± is equivalent
to the standard error of the sample population.

| Calculated Printed | Measured | Measured |
|---|---|---|
| and Sintered Tube | Cured Tube | Sintered Tube |
| ID:OD | ID:OD | ID:OD |
| 0.00 | 0.00 | 0.00 |
| 0.167 | 0.174 ± 0.020 | 0.111 ± 0.030 |
| 0.333 | 0.304 ± 0.021 | 0.276 ± 0.015 |
| 0.500 | 0.498 ± 0.018 | 0.429 ± 0.025 |
| 0.667 | 0.502 ± 0.015 | 0.435 ± 0.015 |

The improved properties of the 3YZ/Ceracer ink contributed to the controlled printing of the DIW tubes with ID's ranging from 0 to 1.265±0.04 mm for the diametral compression testing, as seen in Table 1. Before mechanically testing these materials, the theoretical and measured tube dimensions were compared to determine consistency and accuracy between samples as well as shrinkage of the tubes after partially sintering; Table 2 shows the calculated ID:OD for the printed tubes as well as the measured ID:OD for the cured and sintered tubes. An ink printing limit can be observed for the 250 μm nozzle, where a maximum ID:OD was reached. This is a possible artifact of the ink rheology and surface wetting behavior on the print bed. It was noted that achieving theoretical ID:OD ratio was more difficult for larger ratios of ID:OD as shown in the 0.500 and 0.667 calculated printed and sintered tubes of Table 2.

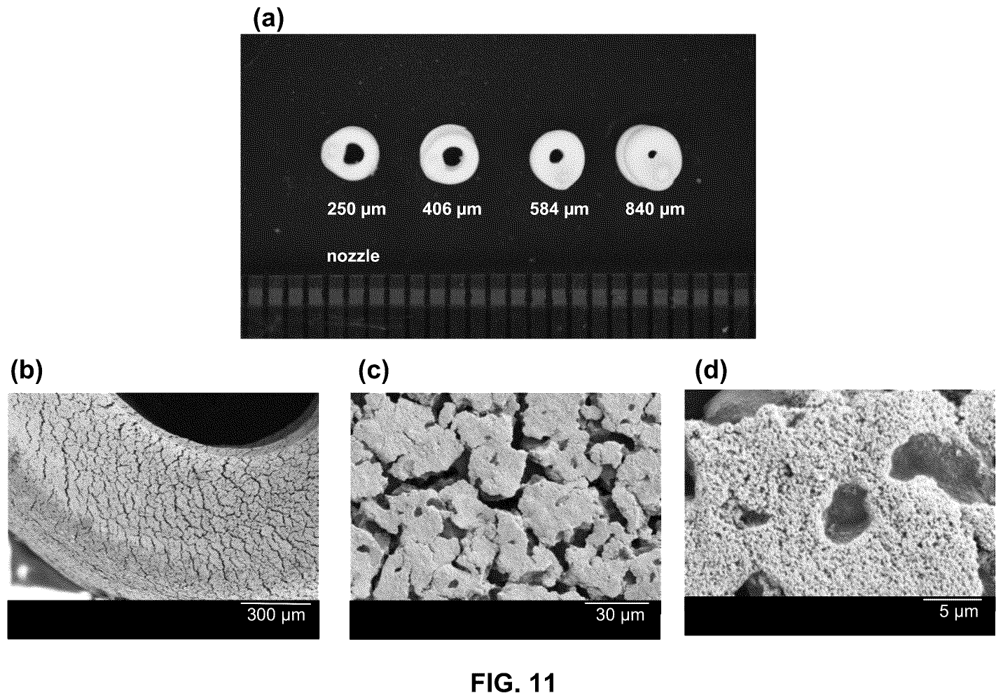

The cured 3YZ tubes feature both macroscopic and microscopic surface cracking with minimal closed microporosity and closed nanoporosity between the 3YZ nanoparticles as shown in FIG. 11. Fracture surfaces of the sintered 3YZ tubes featured a bimodal pore size distribution with microporosity of an approximate diameter of 10 microns and nanoporosity between the 3YZ grains (FIG. 11). Part (a) of FIG. 11 is an image of a series of tube structures having different inner diameters. The numbers correspond to the nozzle diameter used to form the tube structure, e.g., 250 μm, 406 μm, 584 μm, and 840 μm. The larger the nozzle diameter resulted in a tube with a smaller inner diameter. Parts (b), (c), and (d) show SEM images of a top surface of a ceramic tube with increasing magnification. The general pore structure is consistent across the variably sized tubes, suggesting that the sample set strengths can be compared using a Weibull analysis.

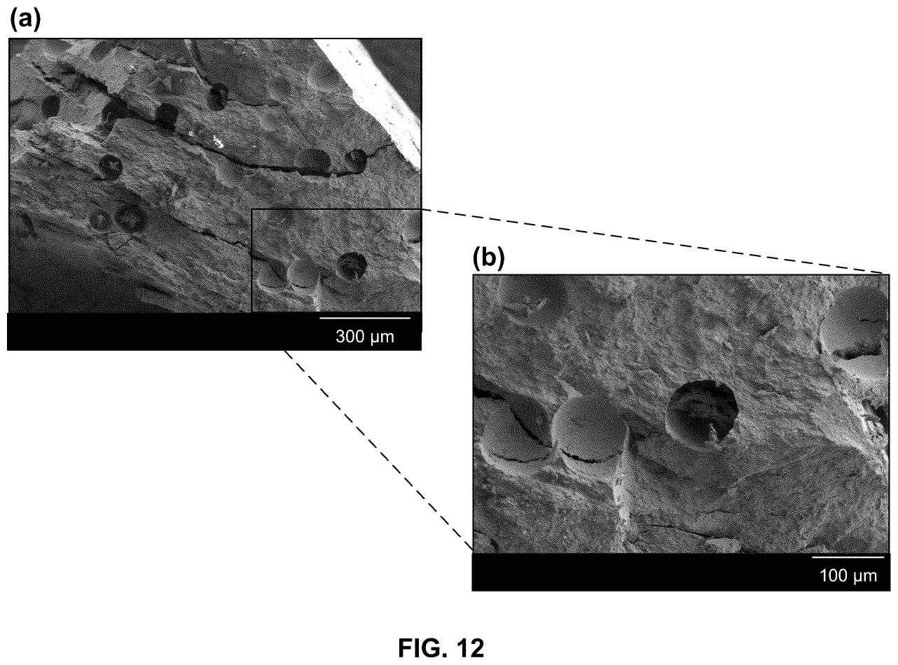

The SEM images of ceramic tubes formed with the secondary pore former polymer Ceracer, as shown in parts (b), (c), and (d) of FIG. 11, show minimized microcracking. This reduction in microcracking was relative to the microcracking demonstrated with ceramic tubes formed with other secondary pore formers. Other secondary pore formers (such as polystyrene beads ˜50-100 μm) produced microcracks that formed originating in the spherical pore left from the beads. Images of ceramic material formed with polystyrene beads as the secondary pore former as shown in FIG. 12, parts (a) and (b), show the larger micro-cracks in the cured material. Some of these cracks grew to several mm in length and became detrimental to the structural integrity of the porous part. These cracks were present at other secondary pore former loadings of only 3 wt. %.

The number of print layers and print layer thicknesses varied between the different sample sets, but these variations were used to control the tube height so that the tube length used in the strength calculation was nominally constant for the Weibull analyses. Referring back to FIG. 11, the images of part (b) and (c) show the micron-sized pores formed from secondary pore former polymers such as polyethylene powder (e.g., Ceracer).

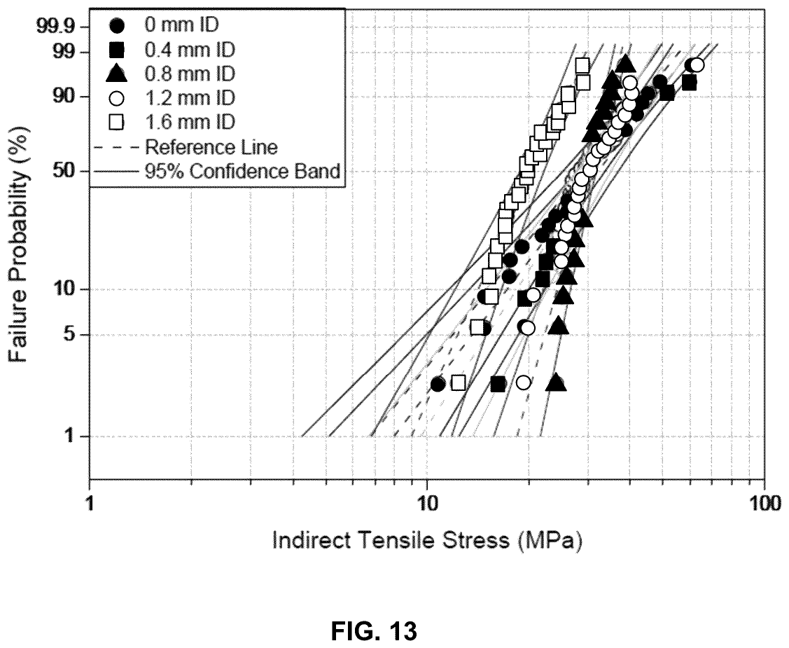

Theoretically, if the relationship formulated by Hobbs is accurate, each of the 3YZ DIW sample sets should have the same characteristic strength; however, there are slight differences in the constructed Weibull distributions (FIG. 13) As predicted, the tubes with smaller inner diameters failed at higher loads as compared to tubes with larger inner diameters. When Hobbs' hole-size corrected diametral compression relationship is applied, all sample sets, except for the 16ID sample set, had a characteristic strength between 31 and 36 MPa. Because the flaw and pore size distributions are mostly identical across the sample sets, the printing process and ink printing limit must be responsible for the lower

TABLE 3
Diametral compression testing summary characteristic
strength value of 22 MPa for the 16ID sample set.

| | Number | Average | Average | | Average | Average | | |
|---|---|---|---|---|---|---|---|---|
| | of | Outer | Inner | Average | Failure | Extension | | Characteristic |
| Sample | Samples | Diameter | Diameter | Length | Load | at Failure | Weibull | Strength |
| mm ID | Tested | mm | mm | mm | N | mm | Modulus | MPa |
| 0 | 30 | 2.33 ± | 0 | 1.66 ± | 29.4 ± | 0.24 ± | 2.9 ± | 33.0 ± |
| | | 0.04 | | 0.02 | 1.7 | 0.02 | 0.4 | 2.2 |
| 0.4 | 30 | 2.25 ± | 0.25 ± | 1.69 ± | 30.1 ± | 0.27 ± | 23.0 ± | 36.1 ± |
| | | 0.05 | 0.01 | 0.01 | 2.1 | 0.02 | 0.4 | 2.3 |
| 0.8 | 30 | 2.25 ± | 0.62 ± | 1.49 ± | 17.7 ± | 0.17 ± | 8.6 ± | 31.4 ± |
| | | 0.02 | 0.01 | 0.01 | 0.4 | 0.01 | 1.2 | 0.7 |
| 1.2 | 30 | 2.19 ± | 0.94 ± | 1.75 ± | 14.9 ± | 0.13 ± | 3.6 ± | 34.5 ± |
| | | 0.03 | 0.02 | 0.01 | 1.0 | 0.01 | 0.4 | 1.9 |
| 1.6 | 30 | 2.23 ± | 0.97 ± | 1.53 ± | 8.2 ± | 0.14 ± | 5.2 ± | 21.9 ± |
| | | 0.02 | 0.01 | 0.02 | 0.3 | 0.01 | 0.7 | 0.8 |

± is equivalent to the standard error of the sample population.

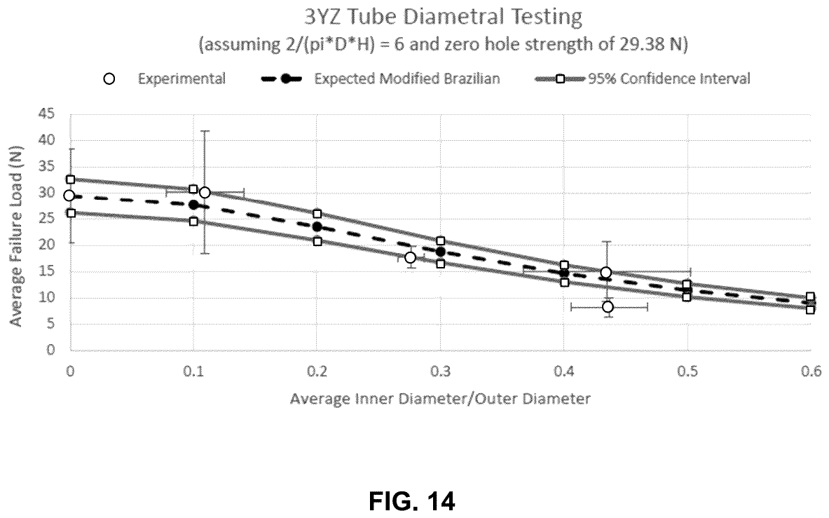

The Weibull modulus was typical for porous ceramics, varying between 3 and 9 and indicating a relatively broad flaw size distribution, with the 08ID sample set having the highest Weibull modulus indicating the narrowest flaw size distribution. A sample dimension and diametral compression summary for each sample set can be seen in Table 3 and FIG. 14.

To assess the effect of dispersants, ceramic inks were prepared with a primary pore former polymer and a dispersant. For example, the following formulations include dispersants, e.g., small polymers, dispersants, etc.).
1. 70 wt. % 3YZ+30 wt. % PEGDA
2. 70 wt. % 3YZ+30 wt. % PEGDA+3 wt. % PEG400
3. 70 wt. % 3YZ+30 wt. % PEGDA+1 wt. % SS20K
4. 70 wt. % 3YZ+30 wt. % PEGDA+0.5 wt. % SS41K

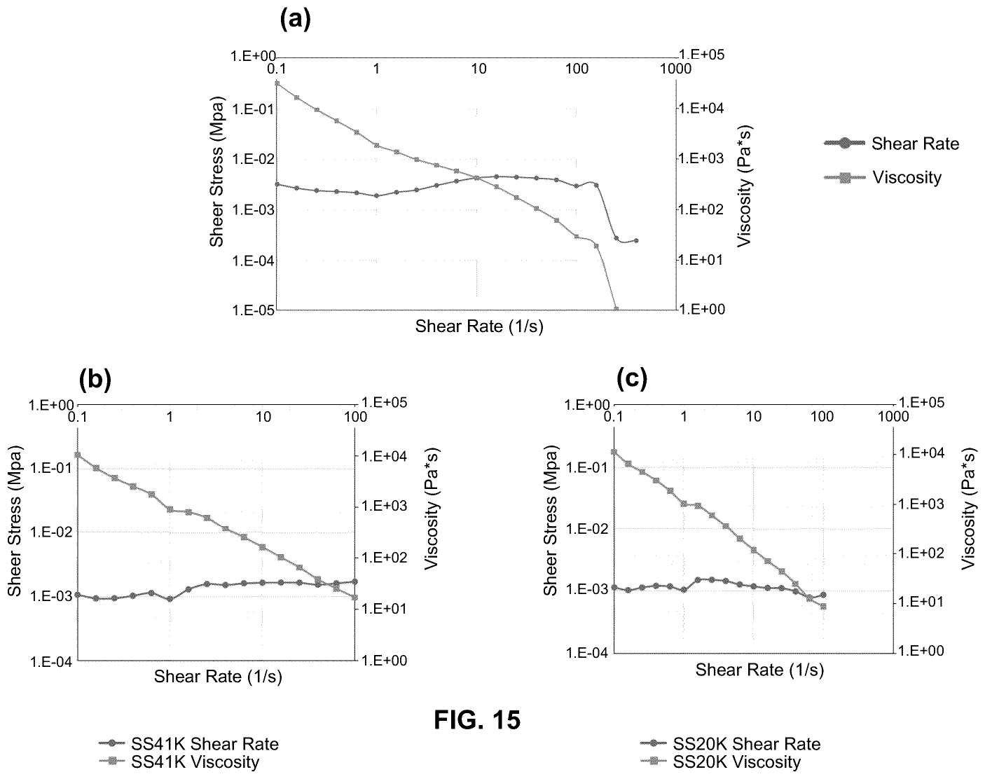

The presence of a dispersant in the ceramic ink improved the shear stress and viscosity of the inks. FIG. 15 illustrates the rheology of an ink that does not include a dispersant (part (a)), rheology of an ink that includes dispersant SS20K (part (b)), and rheology of an ink that includes dispersant SS41K (part (c)). The presence of dispersants in the ceramic ink improved the rheology of the inks (parts (b) and (c)) compared to the rheology of the ceramic ink without dispersant (part (a)).

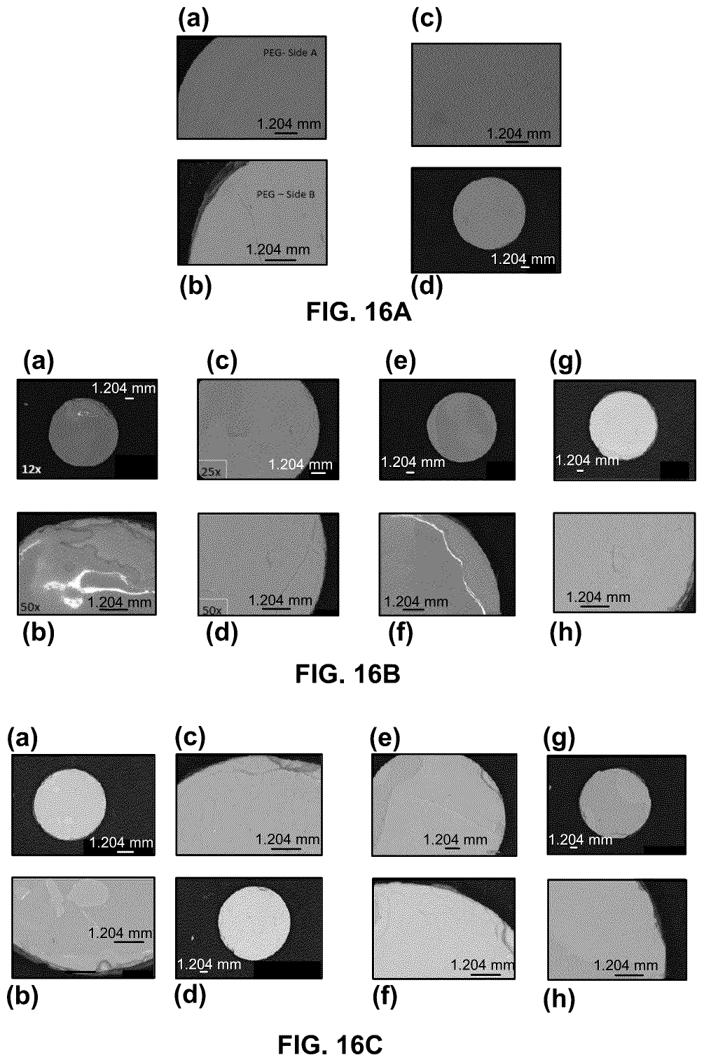

FIGS. 16A to 16C illustrate cast-formed green bodies (after curing) of the ceramic mixture that includes different dispersant. The structures were cured for 12 hrs at 110° C. with 1 hr ramp heat up and cool down. FIG. 16A is a series of images of a cast structures formed with a ceramic mixture with a PEG400 dispersant (Formulation #2). Parts (a) and (b) are images of opposite sides of Structure 1 that shows a crack in Side B (part (b)). Part (c) is a magnified view of Structure 2 depicted in the image of part (d).

FIG. 16B is a series of images of cast structures formed with a ceramic mixture with SS20K dispersant (Formulation #3). The casting process shows the formation of cracks in the structures post curing. Parts (a)-(d) are images of Structure 3, and parts (e)-(h) are images of Structure 4. Part (b) is a magnified view of a portion of the image of part (a) of one side of Structure 3, and part (d) is a magnified view of a portion of the image of part (c) of the opposite side of Structure 3. Part (f) is a magnified view of the crack present in Side A of Structure 4 (part (e)). Part (h) is a magnified view of small “feather-like” cracks in Side B of Structure 4 (part (g)).

FIG. 16C is a series of images of cast structures formed with a ceramic mixture with SS41K dispersant (Formulation #4). The casting process shows an absence of cracks in the structures post curing. Parts (a)-(d) are images of Structure 5, and parts (e)-(h) are images of Structure 6. Part (b) is a magnified view of a portion of the image of part (a) of one side of Structure 5, and part (c) is a magnified view of a portion of the image of part (d) of the opposite side of Structure 5. Part (f) is a magnified view of a portion of Side A Structure 6 (part (e)). Part (h) is a magnified view of portion of Side B of Structure 6 (part (g)).

The addition of surfactants does not affect the properties of the material, such as density and porosity. Inks having a combination of surfactants, dispersants, etc. with the nanoparticles and pore former polymers does not significantly affect the density of the formed structures. For example, as shown in Table 4, the average density of structures formed with three different formulations having different surfactants, dispersants, etc. demonstrated comparable density within a standard deviation.

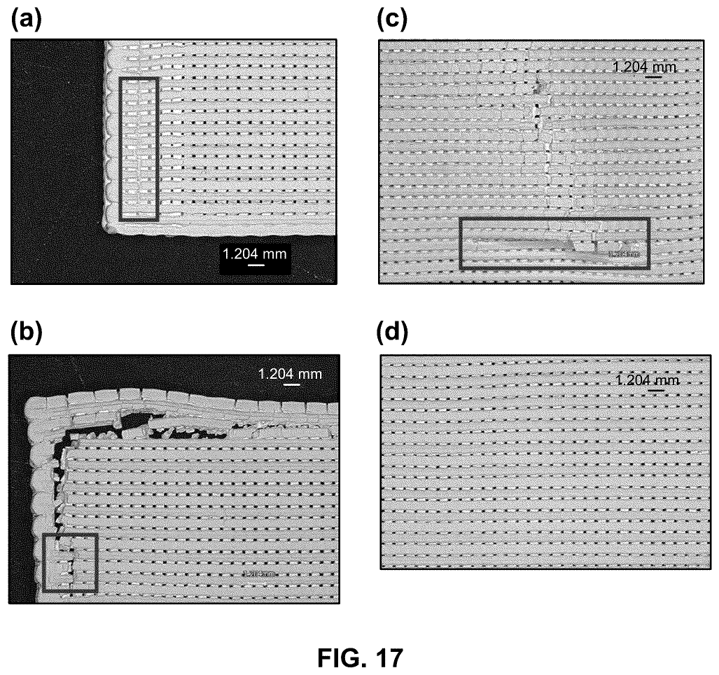

FIG. 17 is a series of images of a lattice formed with a ceramic ink including the dispersant SS41K using DIW printing. The images show the defects in the lattice that form according to the printing conditions of the ink Printing conditions such as pressure applied during extrusion of the ink through the nozzle, and the rate of moving the nozzle during extrusion (e.g., speed of extruding a filament through the nozzle) during printing may affect the formation of a lattice. The image of part (a) shows the edge cracking that can occur. The image of part (b) shows the edge cracking with separation of filaments in the lattice pattern. The image of part (c) shows a raised portion of the lattice. The image of part (d) shows a portion of the lattice formed with preferred printing conditions that result in a uniform lattice pattern without defects.

TABLE 4
Average density of ceramic structures formed with
a ceramic mixture including a dispersant.

| | Average Density | Standard |
|---|---|---|
| Formulation | (g/cm³) | Deviation |
| 3YZ + PEGDA + PEG400 + Luperox | 2.565 | 0.075 |
| 3YZ + PEGDA + SS20K + Luperox | 2.428 | 0.144 |
| 3YZ + PEGDA + SS41K + Luperox | 2.527 | 0.100 |

In Use

Various aspects of an inventive concept described herein may be developed for use to prepare any type of ceramic porous membrane filter in which both nano and micron-sized pores are needed, by tuning the metal oxide:polymer:polymer bead ratio.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A ceramic mixture for forming a ceramic material, comprising
ceramic nanoparticles;
a primary pore former polymer capable of crosslinking;
a secondary pore former polymer configured to form micron-sized pores in the ceramic material; and
a polymerization initiator.

2. The ceramic mixture as recited in claim 1, wherein the ceramic nanoparticles comprise yttria stabilized zirconia.

3. The ceramic mixture as recited in claim 1, wherein the primary pore former polymer is poly(ethyleneglycol) diacrylate.

4. The ceramic mixture as recited in claim 1, wherein the secondary pore former polymer is a polyethylene powder.

5. The ceramic mixture as recited in claim 1, wherein the secondary pore former polymer is a polymer powder comprised of particles, wherein an average diameter of the particles is in a micron range.

6. The ceramic mixture as recited in claim 1, comprising an additive that adsorbs to a surface of the ceramic nanoparticles, the additive being present in an effective amount to promote dispersion of the ceramic nanoparticles in the ceramic mixture.

7. The ceramic mixture as recited in claim 6, wherein the additive is selected from the group consisting of: a non-ionic surfactant, a dispersant, and a lubricant.

8. The ceramic mixture as recited in claim 6, wherein an amount of the additive is in a range of greater than 0 weight % up to about 15 weight % of the weight of the primary pore former polymer.

9. The ceramic mixture as recited in claim 1, wherein the mixture includes a sub-mixture consisting of the ceramic nanoparticles (A) and the primary pore former polymer (B),
wherein A is about 50 to 80 weight % of the total weight of the ceramic mixture,
wherein A+B=100 weight % of the sub-mixture.

10. The ceramic mixture as recited in claim 1, wherein an amount of the secondary pore former polymer is in a range of greater than 0 weight % up to about 15 weight % of a weight of the primary pore former polymer.

11. The ceramic mixture as recited in claim 1, wherein the ceramic mixture is configured as an ink for extrusion-based printing.

12. The ceramic mixture as recited in claim 1, where the ceramic mixture is configured as a resin for light-based lithography printing.

13. A ceramic product, comprising
a printed three-dimensional structure comprising a ceramic material having an open cell structure with a plurality of pores, wherein at least some groups of the pores connect through the ceramic material from one side of the ceramic material to an opposite side of the ceramic material,
wherein the plurality of pores comprise a plurality of nanopores and a plurality of micropores,
wherein a population of the micropores have a predefined size according to a geometry of the printed three-dimensional structure.

14. The ceramic product as recited in claim 13, wherein the printed three-dimensional structure has physical characteristics of formation by an additive manufacturing technique selected from the group consisting of: projection micro-stereolithography and direct ink writing.

15. A method of forming a printed three-dimensional structure comprising a ceramic material, the method comprising:
forming a three-dimensional structure using a ceramic mixture comprising ceramic nanoparticles,
a primary pore former polymer capable of crosslinking,
a secondary pore former polymer configured to form micron-sized pores in the ceramic material, and
a polymerization initiator;
curing the ceramic mixture for crosslinking the primary pore former polymer; and
sintering the structure for removing the polymers and densifying the structure to about a predefined extent.

16. The method as recited in claim 15, wherein the ceramic mixture is an ink for forming the three-dimensional structure using an extrusion-based additive manufacturing technique.

17. The method as recited in claim 15, wherein the ceramic mixture is a resin for forming the three-dimensional structure using a light-based lithography additive manufacturing technique.

18. The method as recited in claim 15, wherein the sintering includes a series of heating steps that include a dwell temperature above 1040 degrees Celsius for less than 8 hours.

19. The method as recited in claim 15, wherein the secondary pore former polymer is a polyethylene powder.

20. The method as recited in claim 15, wherein in the ceramic mixture further comprises an additive that adsorbs to a surface of the ceramic nanoparticles, the additive being present in an effective amount to promote dispersion of the ceramic nanoparticles in the ceramic mixture.
